(19) United States
(12) Patent Application Publication
(10) Pub. No.: US 2012/0283052 A1
(43) Pub. Date: Nov. 8, 2012

(54) TRANSITIONING AND NONLINEAR LACROSSE STICK HANDLES

(76) Inventors: Richard B.C. Tucker, JR., Ruxton, MD (US); Christopher Saturnio, San Marcos, CA (US)

(21) Appl. No.: 13/550,991

(22) Filed: Jul. 17, 2012

Related U.S. Application Data
(63) Continuation-in-part of application No. 12/578,044, filed on Oct. 13, 2009.

(51) Int. Cl. A63B 59/02; B23P 17/00; B29C 49/00; B21D 26/033

(52) U.S. Cl. 473/513; 72/60; 29/428; 264/523

(57) ABSTRACT

An embodiment of the invention provides a monolithic lacrosse stick handle having a first portion, a second portion, and a transition portion disposed between the first and second portion. The first portion has a first cross-section of a first shape. The second portion has a second cross-section of a second shape. The second shape is different from the first shape. Over the transition portion, the cross-sectional shape of the handle transitions from the first shape to the second shape. The handle can be integrally formed from a malleable material. The handle can have varying cross-sectional areas (e.g., wall thicknesses) along its length. A further embodiment provides a lacrosse stick handle that changes in direction, rather than defining a single longitudinal axis as in traditional handles. The nonlinear handle can have, for example, a linear main portion, a curved intermediate portion, and a linear dowel portion.

### CROSS REFERENCE TO RELATED APPLICATION(S)

The present application is a continuation-in-part of U.S. patent application Ser. No. 12/578,044 filed 13 Oct. 2009.

### BACKGROUND OF THE INVENTION

1. Field of the Invention

The present invention relates generally to lacrosse stick handles (also referred to as shafts), and more particularly, to a lacrosse stick handle that changes in direction and/or has a variable cross-section that transitions in shape, size, and/or area over the length of the handle.

2. Description of the Background

The Handling of a lacrosse stick requires a player to hold and control a lacrosse stick handle in specific ways, with many different combinations of hand placement over the length of the handle. A lacrosse player constantly moves his hands along the handle in multiple positions.

In executing game skills, lacrosse players must be able to grip and control the lacrosse stick handle. This control is generally referred to as “stick handling.” Effective stick handling requires a player to constantly reposition his hands along the handle to control the head of the lacrosse stick. As used herein, “stick” refers to the apparatus as a whole, including the handle (or shaft) on which a player's hand(s) is/are placed and the head.

For effective stick handling, each hand placement enables the player to impart force and torque on the lacrosse stick to effect a desired motion, e.g., throwing a ball. In addition, in competitive situations, the player must quickly change hand placements and grips to react to and outplay his opponent. Thus, between the execution of consecutive skills, a player must release or slide one of his hands, move it to a new position, and re-grip the handle with a strong hold.

An example of this constant hand repositioning is a lacrosse player who scoops a ground ball, cradles the ball while running, and then throws the ball. In chasing the ground ball, the player typically grabs the lacrosse stick handle at or near its end with one hand (referred to herein as the “lower hand”) and at or near its midpoint with the other hand (referred to herein as the “upper hand”), and extends the lacrosse stick out in front while running or bending down toward the ground. Once the ball is scooped up and in the pocket of the lacrosse stick head, the player pulls the lacrosse stick toward his body and simultaneously repositions one or both hands, often grabbing the handle with the upper hand just under the throat portion of the lacrosse stick head. While running and cradling the ball, the player may release the lower hand from the bottom of the handle and cradle the stick with the upper hand near the throat portion.

Then, when preparing to throw, the player re-grips the bottom end of the handle and cocks the stick back with both hands. In completing the throwing motion, as the player moves his upper hand forward and lower hand back, the upper hand on the throat area slides down the shaft toward the lower hand. Throughout the throwing and follow-through motions, the lower hand tightly grips the shaft near its end to maintain control and accuracy. Thus, in the course of executing three consecutive game skills, the player quickly repositions his hands multiple times.

The ability to quickly reposition hand placement without losing control of the handle requires a player to make subtle adjustments in hand gripping force. A strong gripping force is required to hold and cock the stick, especially for the lower hand. An intermediate gripping force is required to slide a hand along the shaft without releasing the handle entirely. Such rapid grip adjustments are sometimes difficult to execute on conventional handles, which tend to have largely uniform surfaces that do not cooperate with a player's hand. In addition, factoring in the effects of fatigue, perspiration, cold temperatures, and inclement weather, it is easy to see why players often lose a firm grip on lacrosse stick handles.

In addition, the use of protective gloves can further frustrate a player's firm grip on the lacrosse stick shaft. Although these gloves protect the outside of a player's hand, the layer of material between the shaft and the player's palm and fingers, no matter how tacky, reduces the player's feel for the shaft. Additionally, moisture from, for example, inclement weather makes firm gripping difficult.

To improve the grip, players sometimes tape the shafts with athletic tape, Tourna Grip™, or similar grip materials. Although these minor adjustments may approximate a grip, it is difficult to build shapes out of the tape that complement finger placement and/or that increase the diameter of the handle to aid a player in using the required gripping force. The tape can also add undesirable weight to the lacrosse stick. Furthermore, the tape rarely adheres well to the shaft, tends to slide, and does not move in unison with the shaft. Indeed, the tape is extremely susceptible to wearing, tattering, and falling off. Thus, players must constantly remove and replace the tape.

Lacrosse manufacturers have also added grips, overlays, and other materials to lacrosse stick handles to improve grip. One example is disclosed in U.S. Pat. No. 6,500,079 to Tucker, Sr., which is assigned to the assignee of the present invention, and is incorporated by reference herein. Other designs have altered the orientation or cross-sectional shape of a handle, for example, as disclosed in U.S. Pat. No. 5,048,843 to Dorfi et al. and U.S. Published Patent Application No. 20050282667 to Morrow. Contoured lacrosse stick handles made of composite materials formed by wrapping or lay-ups also exist, although such constructions can suffer from problems with durability (e.g., brittleness) and with feel or texture that hinders hand sliding.

In addition to considerations of hand placement and grip, lacrosse stick designers have experimented with lacrosse sticks that lower the ball position relative to the handle, to promote better stick handling and ball control. When double-wall synthetic lacrosse heads were first introduced, the early designs featured straight handles and straight heads, when viewed from a side elevation facing a sidewall of the head. In other words, the lacrosse head remained largely in line with the axis of the handle. Since those early designs, however, the trend has been to lower the lacrosse head below the handle axis. Lowering the head can enable better ball control and provide a player with an indication of the orientation of the lacrosse head, which results from the uneven weight distribution relative to the handle axis in directions radial to the handle axis. At the same time, however, these offset designs can create difficulties in releasing the ball from the head, and can therefore hinder a player's ability to execute quick and accurate shots and passing. For example, some offset designs can cause a ball to get caught up under the stop area of the lacrosse head. In addition, some offset designs adversely affect or limit hand placement options.

### SUMMARY OF THE INVENTION

One aspect of the present invention provides a lacrosse stick handle having a variable cross-section that transition in shape, size, and/or area over the length of the handle. The different cross-sections can accommodate lacrosse-specific hand movements, in terms of how and where a player grips the handle and slides his hands while playing lacrosse. In addition, the different cross-sections can provide desired degrees of strength, rigidity, and durability at particular locations along the handle, especially by varying the wall thickness of the handle.

An embodiment of the present invention provides a lacrosse stick handle with at least two cross-sectional shapes. The first shape is an extreme concave octagon, provided throughout a lower portion of the handle, approximately from the middle of the handle to the butt end of the handle. The second shape is a teardrop, provided throughout an upper portion of the handle, approximately from the middle of the handle to proximate the end of the handle that connects to the lacrosse head. The handle transitions between the octagonal shape and the teardrop shape, for example, at about the midpoint of the handle, and can then transition again from the teardrop shape to the octagonal shape proximate to the end of the handle for insertion into a socket of the lacrosse head. The cross-sectional shape, length, and location of the octagonal and teardrop portions of the lacrosse stick handle accommodate the gripping, sliding, and carrying techniques unique to lacrosse.

Another embodiment of the present invention also provides a lacrosse stick handle with at least two cross-sectional shapes. The first shape is an octagon that varies in dimension to provide an overall undulating contour to a lower portion of the handle, approximately from the middle of the handle to the butt end of the handle. The undulating contour accommodates the natural shape of a player's hand or fingers and improves grip and comfort. The second shape is a teardrop, provided throughout an upper portion of the handle, approximately from the middle of the handle to proximate the end of the handle that connects to the lacrosse head. The handle transitions between the octagonal undulating shape and the teardrop shape, for example, at about the midpoint of the handle, and can then transition again from the teardrop shape to the octagonal shape proximate to the end of the handle for insertion into a socket of the lacrosse head. The cross-sectional shape, length, and location of the octagonal and teardrop portions of the lacrosse stick handle accommodate the gripping, sliding, and carrying techniques unique to lacrosse. For example, the undulating lower portion enhances grip, while the teardrop portion permits hand sliding, which generally occurs at the upper portion of the handle when a player gets ready to pass or shoot.

Another embodiment of the present invention provides a lacrosse stick handle having varying cross-sectional areas (e.g., wall thicknesses) along its length, which can be provided in a handle having a uniform shape and outer dimensions or in a handle having varying cross-sectional shapes and outer dimensions.

Another aspect of the present invention provides lacrosse stick handles that change in direction, rather than define a single longitudinal axis as in traditional handles. In this aspect, portions of a handle can be canted or curved with respect to other straight portions of the handle. In one implementation, a handle has a main portion and a dowel portion. The main portion of the handle defines a main longitudinal axis. The dowel portion is a short portion at one end of the handle. The dowel portion defines a dowel portion axis that is at an angle to the main longitudinal axis, such that the dowel portion is canted with respect to the main portion. A lacrosse head connected to the dowel portion of the handle can provide an offset lacrosse stick.

In addition to linear angular canting, other embodiments can form curves or combinations of curves and linear angular cants. For example, according to one embodiment, a handle has a linear main portion, a curved intermediate portion, and a linear dowel portion. The curved intermediate portion, which is between the main portion and the dowel portion, offsets the dowel portion from the main portion so that the longitudinal axis of the dowel portion is at an angle to the longitudinal axis of the main portion. This linear-curved-linear configuration yields surprising benefits in comparison to handles that are curved their entire length and to canted handles having only linear sections (e.g., a handle having only a linear main portion and linear dowel portion). Those benefits relate to, for example, hand placement as it affects shooting and passing accuracy and consistency, better positioning of the ball further underneath the hands (when a stick is viewed from the side, with the axis of the main portion of the handle horizontal), and due to the linear dowel portion and the degree of the curve in the curved portion, the ability to accommodate most existing lacrosse heads while complying with commonly accepted lacrosse stick construction rules limiting the total allowable offset of a lacrosse head.

To achieve these variable cross-sections and canted and curved configurations, embodiments of the present invention provide methods for dye forming handles in such configurations, either by hydroforming metal or high pressure bladder molding composite handles within an appropriately shaped mold, to form structures that could not be easily manufactured using conventional techniques such as extrusion and post-extrusion bending. Hydroforming is a specialized type of dye forming that uses a high pressure hydraulic fluid to press room temperature working material into a dye. High pressure bladder molding is also a specialized type of dye forming, albeit different, which uses a pneumatic bladder to press heated working material into a dye. In an embodiment of the present invention, the handle is constructed of a metal or metal alloy, for example, formed by casting or hydroforming. The shaped metal handle can be formed as a monolithic part in one manufacturing step, rather than, for example, a handle made of multiple parts welded together in several steps. The metal alloy can be, for example, a zirconium-aluminum alloy, a vanadium-steel alloy, a vanadium-aluminum alloy, a titanium-aluminum alloy, or a scandium-aluminum alloy.

In another embodiment of the invention, the handle is constructed of a metal or metal alloy, and is shaped by bending, the shaped metal handle being formed as a monolithic part in one manufacturing step.

In yet another embodiment of the present invention, the handle is constructed of any polymer-based composite material, including fiberglass, carbon fiber, or Kevlar™, for example, formed by high pressure bladder molding. The shaped composite handle can be formed as a monolithic part in one manufacturing step, rather than, for example, a handle made of multiple parts welded together in several steps.

The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1A is a schematic diagram of a transitioning lacrosse stick handle having octagonal and teardrop portions, according to an embodiment of the present invention.

FIG. 1B is a schematic diagram of a cross-sectional perspective view of a portion of the handle of FIG. 1A over which a transition in cross-sectional shape occurs.

FIG. 1C is a schematic diagram of a perspective view of a portion of the handle of FIG. 1A over which a transition in cross-sectional shape occurs.

FIG. 1D is a schematic diagram of a cross-section of a teardrop portion of the handle of FIG. 1A.

FIG. 1E is a schematic diagram of a cross-section of an extreme concave octagonal portion of the handle of FIG. 1A.

FIG. 1F is a schematic diagram of a cross-section of an octagonal portion of the handle of FIG. 1A.

FIG. 1G is a schematic diagram of side and cross-sectional views of a transitioning lacrosse stick handle having extreme octagonal and teardrop portions, according to a specific implementation of an embodiment of the present invention.

FIG. 1H is a schematic diagram of a representative detailed cross-section of a teardrop portion of the transitioning lacrosse stick handle of FIG. 1G.

FIG. 1I is a schematic diagram of a representative detailed cross-section of an octagonal portion of the transitioning lacrosse stick handle of FIG. 1G.

FIG. 1J is a schematic diagram of another side view of the lacrosse stick handle shown in FIG. 1G, with the handle rotated ninety degrees around its longitudinal axis relative to its position in FIG. 1G.

FIG. 2A is a schematic diagram of a transitioning lacrosse stick handle having octagonal and undulating portions, according to another embodiment of the present invention.

FIG. 2B is a schematic diagram of a portion of the handle of FIG. 2A having an undulating contour to accommodate a player's hand or fingers.

FIG. 2C is a schematic diagram of a cross-sectional perspective view of a portion of the handle of FIG. 2A over which a transition in cross-sectional shape occurs.

FIG. 2D is a schematic diagram of a cross-sectional view of an octagonal portion of the handle of FIG. 2A.

FIG. 2E is a schematic diagram of side and end views of a transitioning lacrosse stick handle having octagonal and undulating portions, according to a specific implementation of an embodiment of the present invention.

FIG. 2F is a schematic diagram of a detailed end view of the octagonal portion of the tran

FIG. 2G is a schematic diagram of a detailed end view of the butt end of the transitioning lacrosse stick handle of FIG. 2E.

FIG. 2H is a schematic diagram of a cross-sectional view of the transitioning lacrosse stick handle of FIG. 2E taken along line A-A.

FIG. 2I is a schematic diagram of a cross-sectional view of the transitioning lacrosse stick handle of FIG. 2E taken along line B-B.

FIG. 2J is a schematic diagram of another side view of the lacrosse stick handle shown in FIG. 2E, with the handle rotated ninety degrees around its longitudinal axis relative to its position in FIG. 2E.

FIGS. 3A-3B illustrate another embodiment of a transitioning lacrosse stick handle 300 according to a “taped” embodiment of the present invention.

FIGS. 4A-4E are schematic diagrams illustrating lacrosse handles having variable wall thicknesses, according to an embodiment of the present invention.

FIG. 5A is a schematic diagram illustrating a lacrosse handle having a linear-curved-linear configuration, according to an embodiment of the present invention.

FIGS. 5B, 5C, and 5D are schematic diagrams of a bottom view, side view, and end view, respectively, of a lacrosse handle having a linear-curved-linear configuration, according to an embodiment of the present invention.

FIG. 5E is a schematic diagram of a cross-section of the lacrosse handle of FIGS. 5B and 5C, taken at section B-B of FIG. 5C, according to an embodiment of the present invention.

FIG. 5F is a schematic diagram of a lacrosse handle having a linear-curved-linear configuration, in which the longitudinal axis of the linear dowel portion is parallel to the longitudinal axis of the linear main portion, according to an alternative embodiment of the present invention.

FIG. 6 is a schematic diagram illustrating a lacrosse handle having a linear dowel portion canted with respect to a linear main portion, according to an embodiment of the present invention.

FIGS. 7(A-D) are schematic diagrams illustrating a method for making a transitioning lacrosse stick handle, according to an embodiment of the present invention.

FIG. 8 is an example of a suitable composite preform 200 approximating the shape of a handle having a linear-curved-linear configuration according to the embodiment of FIG. 5A.

FIG. 9 is an example of a suitable clamshell mold 300 for forming the above-described lacrosse handles having variable cross-sectional shapes, sizes, and/or areas.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

An embodiment of the present invention provides a lacrosse stick handle having cross-sections of varying shapes over different portions of the handle. Each shaped portion accommodates a particular hand movement unique to lacrosse stick handling, such as sliding a hand along the length of the handle or gripping a handle to whip the lacrosse stick along its longitudinal axis or to resist torque applied to the lacrosse stick around its longitudinal axis. The cross-sectional shapes are specially located and structured to provide the handle with structural and tactile features that correspond to the way in which a player moves his hands along the handle and grips the handle.

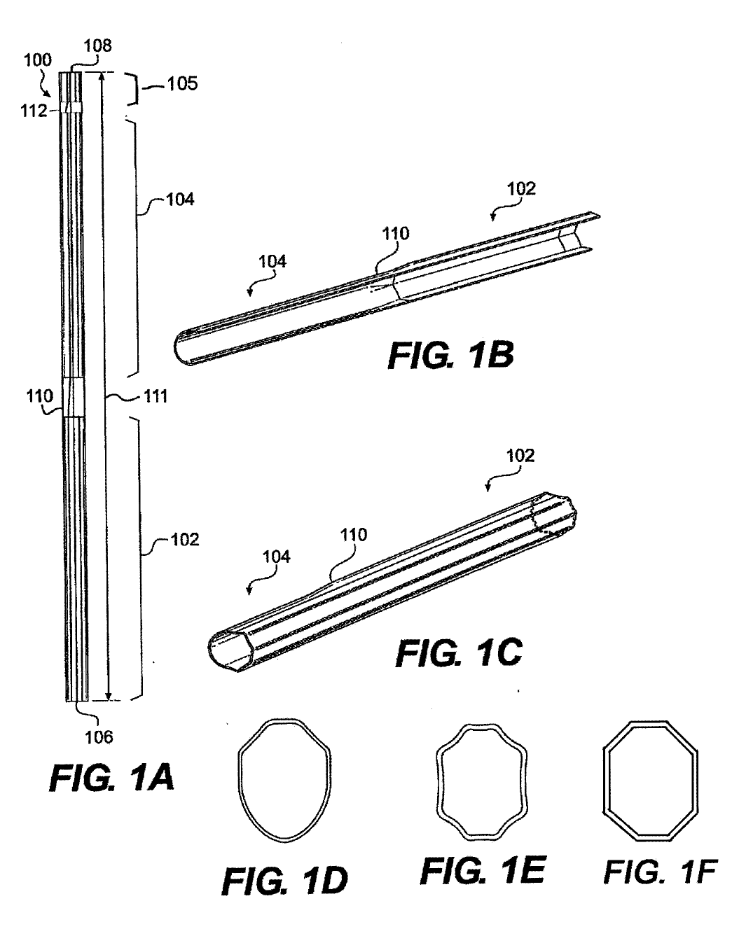

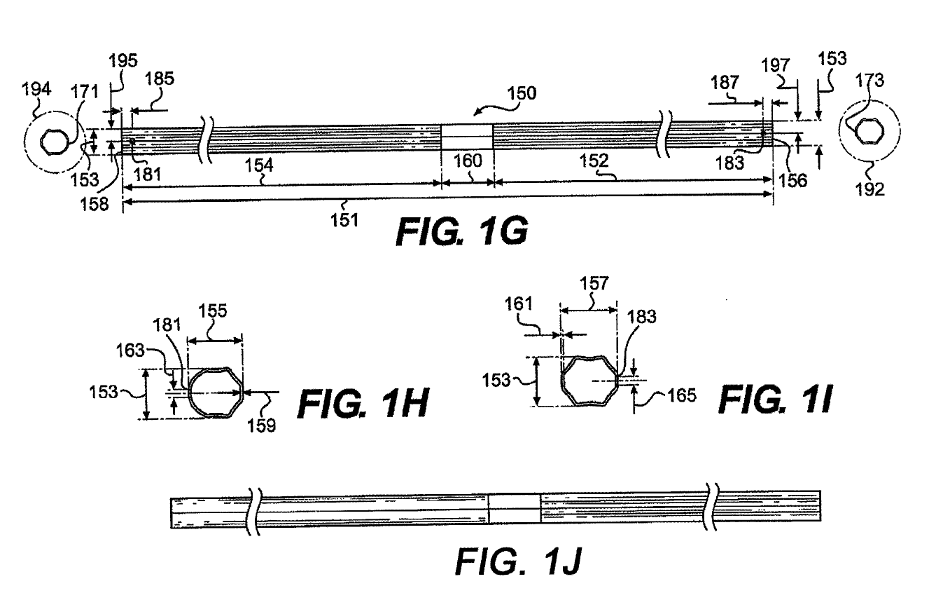

FIGS. 1A-1F illustrate a transitioning lacrosse stick handle 100 according to an embodiment of the present invention, which can attach to a lacrosse head (not shown) to provide a complete lacrosse stick. The typical features of a lacrosse stick are all shown generally in Tucker et al., U.S. Pat. No. 3,507,495 and Tucker et al., U.S. Pat. No. 5,566,947, which are both incorporated by reference herein.

As shown in FIG. 1A, handle 100 generally comprises a hollow, elongate member having a cross-sectional shape taken at right angles lengthwise along the handle 100, which cross-sectional shape varies lengthwise along the handle 100 from a first cross-sectional shape which is uniform along a first length at one end of handle 100, a second cross-sectional shape which is uniform along a second length at the other end of handle 100, and one or more transitions between or distal to the foregoing lengths in which the cross-section transitions lengthwise, e.g., transitioning from the first cross-sectional shape to the second cross-sectional shape. By way of example, the embodiment of FIG. 1A includes a lower portion 102 having an extreme concave octagonal cross-section (see FIG. 1E), the lower portion 102 extending from approximately the middle of the handle 100 to the butt end 106 of the handle 100. Handle 100 further includes an upper portion 104 having a teardrop cross-section (see FIG. 1D), the upper portion 104 extending from approximately the middle of the handle 100 to proximate the end 108 of the handle 100 that connects to a lacrosse head. Proximate to end 108, at first transition region 112, handle 100 can transition from teardrop upper portion 104 to a standard octagonal cross-section (see FIG. 1F) for insertion into the socket of a lacrosse head that accepts octagonally shaped handles. The overall length 111 of the handle can be, for example, 32 inches.

FIGS. 1A-1C illustrates a second transition portion 110 between the octagonal lower portion 102 and teardrop upper portion 104. As shown, the contours of the handle preferably transform smoothly from one shape to the other. Hydroforming the handle 100 out of metal within an appropriately shaped mold, as described in more detail below, can help achieve this smooth transition. Alternatively handle 100 can be formed by high pressure bladder molding of a composite material, also as described below. Both processes can help maintain a constant wall thickness throughout the different shapes. That control over the wall thickness is beneficial in ensuring the strength and rigidity of a handle, and represents a significant advance over traditional manufacturing methods such as extrusion, which cannot easily vary shapes while maintaining a desired wall thickness.

Handle 100 thus provides two or more different cross-sectional shapes in one lacrosse handle, affording the torque-resisting and grip enhancing properties of the extreme concave octagonal cross-section in the lower portion 102, and the slide-favorable properties of the teardrop cross-section in the upper portion 104.

FIGS. 1G-1J illustrate a specific implementation of a transitioning lacrosse stick handle 150 having octagonal and teardrop portions, according to an embodiment of the present invention. FIG. 1G illustrates side and cross-sectional views of the transitioning lacrosse stick handle 150, with octagonal portion 152, teardrop portion 154, and a transition portion 160 in between the octagonal portion 152 and the teardrop portion 154. The length of octagonal portion 152 can be about 368 mm, for example. The length of teardrop portion 154 can be about 394 mm, for example. The length of transition portion 154 can be about 51 mm, for example. The overall length 151 of handle 150 can be about 813 mm, for example.

The views 192, 194 show end views or representative cross-sections of the octagonal portion 152 and teardrop portion 154, respectively. In this implementation, the handle 150 has a uniform width 153 of about 22.4 mm, for example. The teardrop portion 154 and octagonal portion 152 are oriented so that the peak 171 of the rounded portion of the teardrop cross-section and the midpoint of a small side 173 of the octagonal cross-section are along the same longitudinal line approximately in the midpoint of the width of the handle, as represented by dimension 195 and 197. With a width 153 of 22.4 mm, dimension 195 and 197 can be approximately 11.2 mm, for example.

FIG. 1H is a schematic diagram of a representative detailed cross-section of a teardrop portion of the transitioning lacrosse stick handle 150 of FIG. 1G. Width 153 can be about 22.4 mm, for example, as mentioned above. Depth 155 can be about 27.1 mm, for example. The wall thickness 159 can be about 1.2 mm, for example. Referring to FIGS. 1G and 1H, a hole 181 can be formed proximate the end 158 of teardrop portion 154, for receiving a fastener to fasten a lacrosse head, butt cap, or other accessory to the handle 150. The distance 185 from the end 158 at which hole 181 is located can be, for example, about 9.4 mm. As shown in FIG. 1G, the hole 181 can be centered along the width 153 at a distance 195 of about 11.2 mm from either end of width 153. The hole 181 can be about 3.2 mm in diameter, for example.

FIG. 1I is a schematic diagram of a representative detailed cross-section of an octagonal portion of the transitioning lacrosse stick handle 150 of FIG. 1G. Width 153 can be about 22.4 mm, for example, as mentioned above. Depth 157 can be about 27.1 mm, for example. The wall thickness 161 can be about 1.2 mm, for example. Referring to FIGS. 1G and 1I, a hole 183 can be formed proximate the distal end 156 of octagonal portion 152, for receiving a fastener to fasten a lacrosse head, butt cap, or other accessory to the handle 150. The distance 187 from the distal end 156 at which hole 183 is located can be, for example, about 9.4 mm. As shown in FIG. 1G, the hole 183 can be centered along the width 153 at a distance 197 of about 11.2 mm from either end of width 153. The hole 183 can be about 3.2 mm in diameter, for example.

FIG. 1J illustrates another side view of the lacrosse stick handle shown in FIG. 1G, with the handle rotated ninety degrees around its longitudinal axis relative to its position in FIG. 1G.

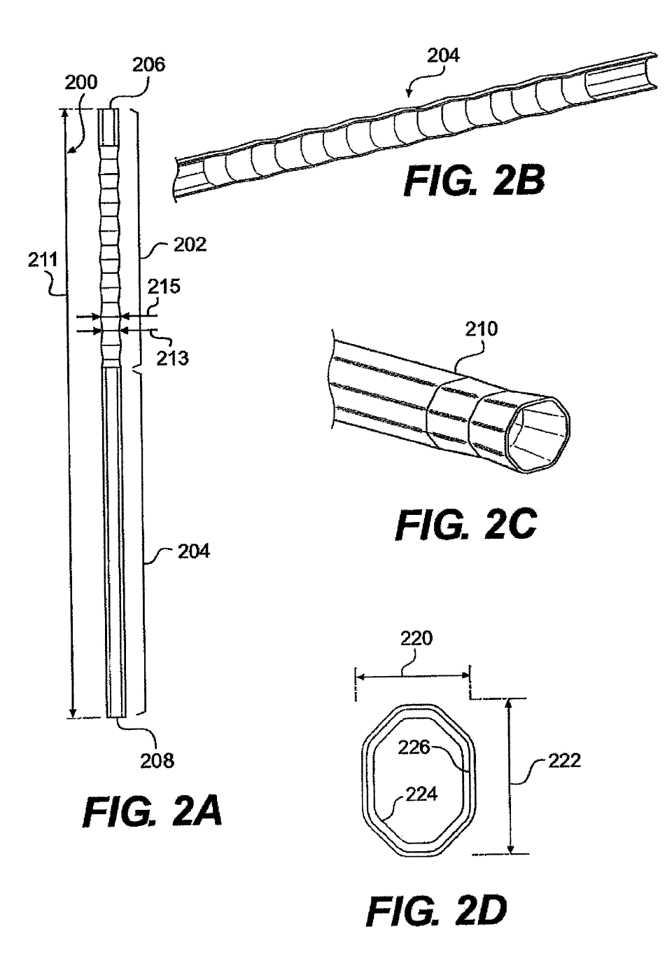

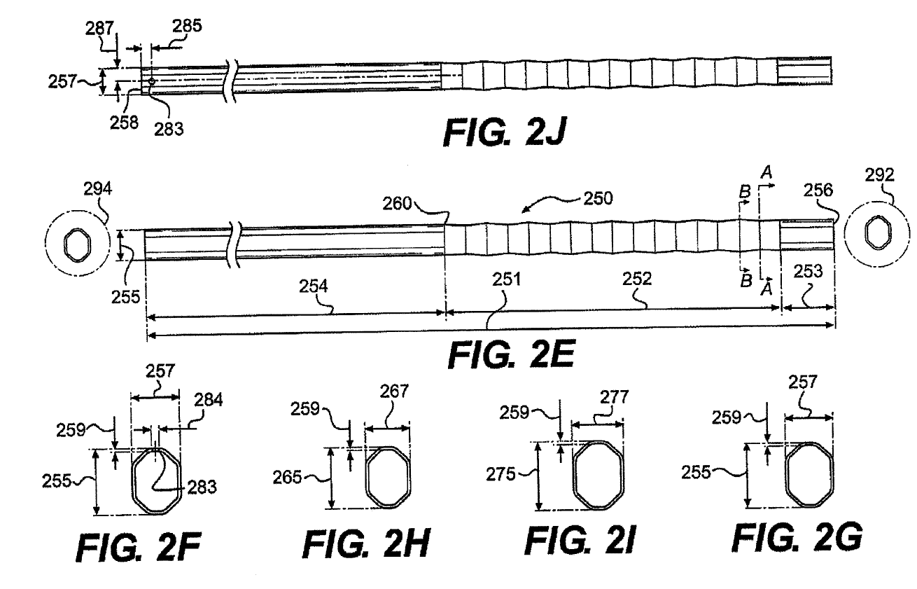

FIGS. 2A-2D illustrate a transitioning lacrosse stick handle 200 according to another embodiment of the present invention, which can attach to a lacrosse head (not shown) to provide a complete lacrosse stick, as with the lacrosse handle 100 of FIGS. 1A-1E. As shown in FIG. 2A, handle 200 includes a lower portion 202 and an upper portion 204. Lower portion 202 extends from approximately the middle of the handle 200 to the butt end 206 of the handle 100, and has a rounded edge octagonal cross-section (see FIG. 2D) of varying dimensions.

As shown in FIGS. 2A and 2B, within the lower portion 202, the outer dimensions of the rounded edge octagon cross-section increase and decrease to provide an oscillatory surface texture along the length of the lower portion 202. In this embodiment the oscillatory surface texture is undulating in a sinusoidal manner, adding an undulating contour to the handle which accommodates a player's hand or fingers. For example, as shown in FIGS. 2A and 2D, the width 220 can vary (e.g., in a sinusoidal wave) between a minimum width 213 of about 1 inch to a maximum width 215 of about 1.2 inches, with the height 222 remaining constant. The cross-sectional view of FIG. 2D illustrates the undulations of lower portion 202 inside handle 200, showing the minimum inside dimensions 224 and maximum inside dimensions 226 of the lower portion 202. At the end of lower portion 202 nearest butt end 206, handle 200 can transition from the undulating contour to an octagonal cross-section to accept a standard butt cap, as shown in FIG. 2A.

Upper portion 204 extends from approximately the middle of the handle 200 to proximate to the end 208 of the handle 200 that connects to a lacrosse head. Upper portion 204 of handle 100 can have a constant outer dimension shaped, for example, as a rounded edge octagonal cross-section or a teardrop cross-section (as in FIG. 1E). In any case, if necessary, proximate to end 208, handle 200 can transition back to an octagonal cross-section for insertion into the socket of a lacrosse head that accepts octagonally shaped handles. The length 211 of the handle can be, for example, 32 inches.

FIG. 2C illustrates the transition 210 between the undulating lower portion 202 and the constant outer dimension upper portion 204. As shown, the contours of the handle preferably transform smoothly from one shape to the other. High pressure bladder molding the handle 200 within an appropriately shaped mold can help achieve this smooth transition. Alternatively, hydroforming the handle 100 out of metal within an appropriately shaped mold can help achieve this smooth transition. Handle 200 thus provides two different cross-sectional shapes in one lacrosse handle, affording the torque-resisting and grip enhancing properties of the undulating lower portion 202, and the slide-favorable properties of the constant outer dimension cross-section of the upper portion 204.

FIGS. 2E-2J illustrate a specific implementation of a transitioning lacrosse stick handle 250 having a constant-dimension octagonal portion and an undulating octagonal portion, according to an embodiment of the present invention. FIG. 2E illustrates side and end views of the transitioning lacrosse stick handle 250, with a constant-dimension octagonal portion 254, an undulating octagonal portion 252, a transition portion 260 in between the octagonal portion 254 and the undulating portion 252, and a butt end portion 253 on a side of the undulating portion 252 opposite to the transition portion 260. The length of octagonal portion 254 can be about 460 mm, for example. The length of undulating portion 252 can be about 305 mm, for example, inclusive of the transition portion 260. The total length 251 of handle 250 can be about 813 mm, for example. As shown and explained in more detail below, transition portion 260 transitions from the minimum dimension of the undulating portion 252 (as represented by cross-section A-A in FIGS. 2E and 2H) to the dimensions of the constant-dimension octagonal portion 254. The length of butt end portion 253 can be about 48 mm, for example.

The views 292, 294 show end views of the butt end portion 253 and octagonal portion 254, respectively. In this implementation, the octagonal portion 254 and butt end portion 253 have uniform shapes, dimensions, and orientations as shown in the detailed end views of FIGS. 2F and 2G, with, for example, a width 255 of about 27 mm, a depth 257 of about 22 mm, and a wall thickness 259 of about 1 mm.

FIGS. 2H and 2I illustrate cross-sections of the undulating portion 252 of transitioning lacrosse stick handle 250 of FIG. 2E, taken at lines A-A and B-B, respectively. FIG. 2H illustrates a minimum dimension of undulating portion 252, while FIG. 2I illustrates a maximum dimension of undulating portion 252. As shown in FIG. 2H, at the minimum dimension, the width 265 can be, for example, about 25.5 mm and the depth 267 can be, for example, about 20.8 mm. As shown in FIG. 2I, at the maximum dimension, the width 275 can be, for example, about 28.6 mm and the depth 277 can be, for example, about 24 mm. The wall thickness throughout the undulating portion 252 can be about 1.2 mm, for example.

FIG. 2J illustrates another side view of the lacrosse stick handle shown in FIG. 2E, with the handle rotated ninety degrees around its longitudinal axis relative to its position in FIG. 2E. Referring to both FIG. 2J and also FIG. 2F, the depth 257 of octagonal portion 254 and butt end portion 253 is, for example, about 22.4 mm. A hole 283 can be formed proximate the distal end 258 of octagonal portion 252, for receiving a fastener to fasten a lacrosse head, butt cap, or other accessory to the handle 250. The distance 285 from distal end 258 at which hole 283 is located can be, for example, about 9.4 mm. The diameter 284 of hole 283 can be about 6.4 mm, for example. As shown in FIG. 2J, the hole 283 can be centered along the depth 257 at a distance 287 of about 11.2 mm from either end of depth 257. Although not shown, another hole similar to the size and placement of hole 283 could be formed proximate to the distal end 256 of the butt end portion 253.

In a further embodiment of the present invention, a butt cap of a handle is formed integrally with the monolithic handle and integrated into the overall shape of the handle. In this manner, the butt end (such as ends 106 and 206 of FIGS. 1A and 2A respectively) is closed and shaped as desired to improve grip on the handle. The shape of the butt end can be molded directly into the end of the handle by, for example, hydroforming metal or high pressure bladder molding composite. As an example, the butt end can be conically shaped with a diameter or other outer dimension that increases toward the butt end of the handle. The butt end (or any other portion of the handle) can also be fanned with texture, such as bumps, nubs, protrusions, grooves, dimpling, knurling, or longitudinal, lateral, or diagonal ridges.

The overall structure of the handle can also vary in outer dimensions or profile to prevent a player's hand from sliding over the end of the overlay and off of the shaft. For example, to improve the gripping of the lacrosse stick at the end opposite to the head, the outer dimensions could increase toward the end of the lacrosse stick handle. The resulting substantially conical shape can help prevent the player's hand from slipping off of the end of the handle. The conical shape can also provide the player's hand with more leverage over the shaft, allowing the player to impart increased torque on the lacrosse stick and to achieve better overall control.

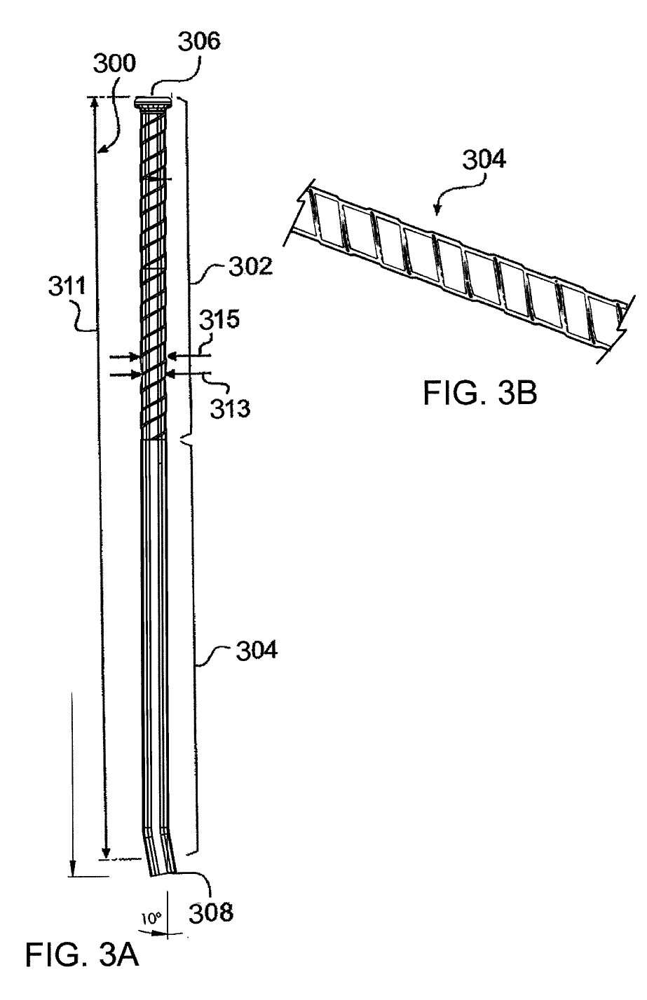

FIGS. 3A-3B illustrates another embodiment of a transitioning lacrosse stick handle 300 having an undulating surface texture according to a “taped” embodiment of the present invention. Here the surface texture replicates tape wound about the handle, either in a helix (where surface texture comprises a stepped ramp along the handle length), or in rings (where surface texture is a step wave). In both cases the surface texture replicates tape wound about the handle, along at least one-third its length.

As shown in FIG. 3A, handle 300 includes a lower portion 302 and an upper portion 304. Lower portion 302 extends from approximately the middle of the handle 300 to the butt end 306 of the handle 300, and generally has a rounded-edge octagonal cross-section (as in FIG. 1F). However, as shown in FIGS. 3A and 3B, within the lower portion 302, the outer dimensions of the rounded edge octagon cross-section increase and decrease to provide an undulating “taped” contour to the handle, which simulates the use of fabric adhesive tape to provide both a better grip as well as a tactile indication of the position of a player's hand or fingers. For example, as shown in FIGS. 3A and 3B, the width 320 can vary (e.g., in a step wave or ramp wave surface pattern along the length of handle 300) between a minimum width 313 of about 1 inch to a maximum width 315 of about 1.2 inches, with the height 322 remaining constant. The cross-sectional view of FIG. 3B illustrates the stepped undulations of lower portion 302 inside handle 300, showing the minimum inside dimensions 324 and maximum inside dimensions 326 of the lower portion 302. At the end of lower portion 302 nearest butt end 306, handle 300 can transition from the undulating contour to an octagonal cross-section to accept a standard butt cap 306, as shown in FIG. 3A.

Upper portion 304 extends from approximately the middle of the handle 300 to proximate to the end 308 of the handle 300 that connects to a lacrosse head. Proximate to end 308, handle 300 can be formed with a 10 degree angle for insertion into the socket of a lacrosse head that accepts octagonally shaped handles. The length 311 of the handle can be, for example, 32 inches.

In a further embodiment of the present invention, a lacrosse stick handle has cross-sections of varying cross-sectional area along its length. As used herein, cross-sectional area refers to the area of the material of the handle when it is cut in cross-section (and does not include the hollow area in the cross section). This cross-sectional area is related to the wall thickness of the handle. In this embodiment, the cross-sectional area can vary along a handle having a uniform cross-sectional shape (e.g., a uniform outer profile) or can vary along a handle having varying cross-sectional shapes as described above.

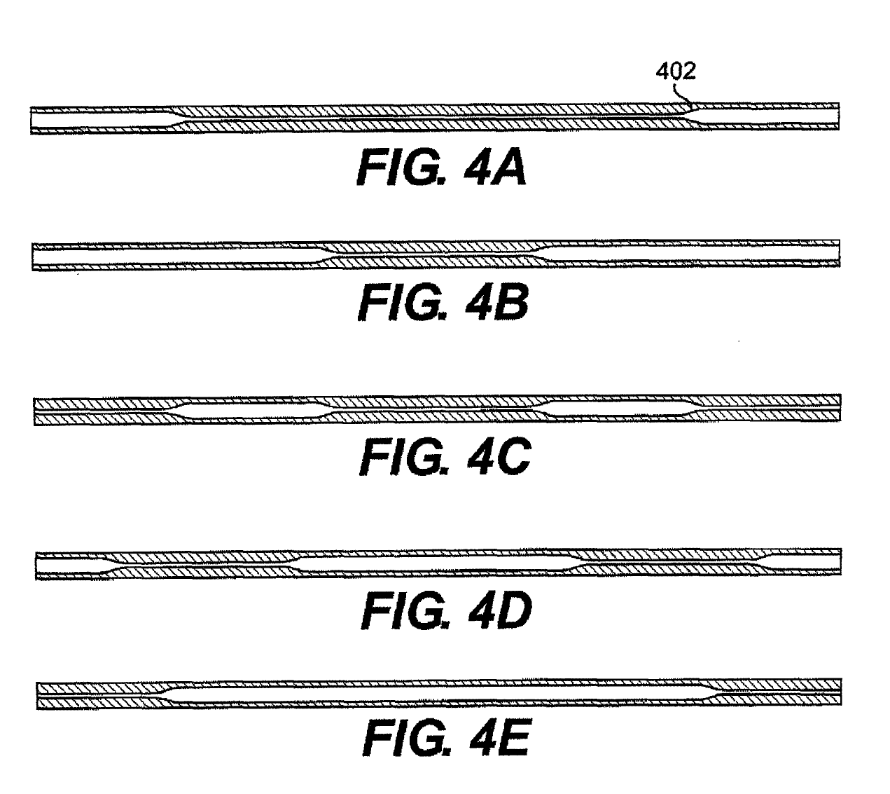

As examples of this embodiment, FIGS. 4A-4E illustrates lacrosse stick handles having variable wall thicknesses and uniform outside dimensions and shapes. The portions of increased wall thickness can provide strength to desired locations of the handle. As shown, the cross-sectional area can be increased in one location (as in FIGS. 4A and 4B) or in multiple locations (as in FIGS. 4D and 4E showing two locations, or in FIG. 4C showing three locations). The handles can also include transition portions (e.g., at point 402 in FIG. 4A) disposed between the portions of differing cross-sectional area, over which the handle transitions from a first cross-sectional area to a second cross-sectional area.

In addition to varying wall thicknesses, the present invention can also form structures within a hollow handle that improve durability, strength, and resistance to bending and breaking. For example, when viewed in cross-section, one embodiment provides a strut connected to opposing interior walls spans the hollow interior of a handle in a configuration akin to an I-beam. As a further example, when viewed in cross-section, another embodiment provides two struts orthogonal to each other, each connected to opposing interior walls and spanning the hollow interior of the handle in a “T” configuration. Although FIGS. 1D, 1E, 1F, 1G, 1H, 1I, 2D, 2E, 2F, 2H, 2I, 2G, 3A and 3B depict particular cross-sections or open ends, the invention is not limited to the particular depicted shapes, dimensions, areas, or proportions. Indeed, the present invention could incorporate other shapes such as circles or ovals, as well as other outer dimensions, inner dimensions, and wall thicknesses. Therefore, notwithstanding the particular benefits associated with the shapes, dimensions, areas, and proportions shown and described herein, the present invention should be considered broadly applicable to any lacrosse handle having varying cross-sections.

In addition, although embodiments shown in the figures include two cross-sectional shapes, the invention encompasses a lacrosse stick handle having any number of cross-sectional shapes, including three or more. For example, an embodiment of the present invention could have three different cross-sectional shapes, such as octagonal, undulating, and teardrop, with transition portions between each of the differently shaped portions. The invention is therefore not limited to any particular number of different cross-sectional shapes, sizes, or areas.

Overall, embodiments of the present invention providing a handle with multiple cross-sectional shapes, sizes, and areas afford significant, unexpected benefits to a lacrosse stick. The shapes (e.g., the teardrop shape) can provide hand registration on the handle, which can prompt a player for optimal hand placement on the handle and enable the player to feel the orientation of the lacrosse stick (i.e., which way the ball receiving side of the lacrosse head is facing) without looking at the lacrosse stick. The changes in shape can also add strength to a handle, for example, transitioning from a traditional teardrop shape to an octagonal shape to add strength. The changes in cross-sectional area can likewise add strength to a handle where desired. The invention can also incorporate unique shapes that are aesthetically pleasing and structurally sound, with multiple profiles and cross sections, and seamless transitions between the different shapes. The cross-sectional shapes can also incorporate shapes that accommodate palm and finger placement, for example, providing bumps, undulations, or indents strategically located to improve throw and shooting accuracy and the overall balance and stability of the stick. The specially shaped handle can also increase the surface area of the handle to improve a player's grip on the handle, without adding undesirable weight to the entire lacrosse stick.

A further aspect of the present invention provides varying cross-sectional shapes, sizes, and areas at the ends of a lacrosse handle. For example, as described above, a butt end or cap can be integrally formed at an end of a handle. As another example, the end of a handle can be specially formed to accommodate connections to a lacrosse head or to other accessories, such as a separate butt cap. In one implementation, an end of a handle changes in shape and dimension to match the shape and dimension of the receiving connection (e.g., socket) on a lacrosse head. For example, women's handles that are ⅞ inches wide can be enlarged at one end to increase the width to 1 inch, which is a typical size of a socket in a lacrosse head. The specially formed end would therefore obviate the need for adapters, which are commonly used in conventional configurations to attach a ⅞-inch women's handle to a standard 1-inch socket of a lacrosse.

Other types of connections could also be specially formed in the end of a handle. For example, mechanical fittings such as threads could be formed at the end of handle such that the handle could be screwed into a lacrosse head having a correspondingly tapped socket. As another example, the end of a handle could be formed to provide a compression fit or interference fit with a corresponding fitting on a lacrosse head.

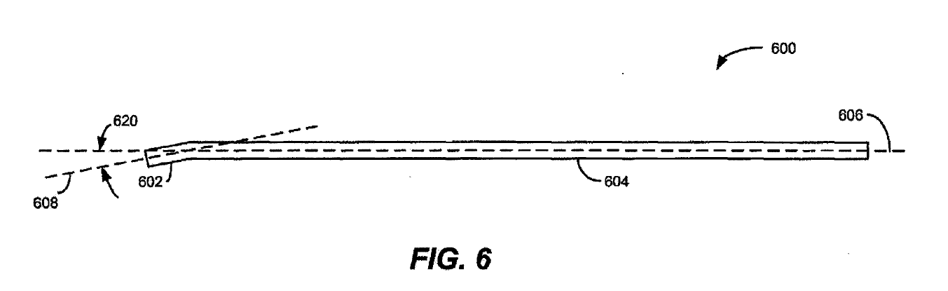

Another embodiment of the present invention provides lacrosse stick handles that change in direction, rather than define a single longitudinal axis as in traditional handles. In this aspect, portions of a handle can be canted or curved with respect to other straight portions of the handle. In one implementation, as shown in FIG. 6, a handle 600 has a main portion 604 and a dowel portion 602. The main portion 604 of the handle 600 defines a main longitudinal axis 606. The dowel portion 602 is a short portion at one end of the handle 600. The dowel portion 602 defines a dowel portion axis 608 that is at an angle 620 to the main longitudinal axis 606, such that the dowel portion 602 is canted with respect to the main portion 604. A lacrosse head connected to the dowel portion 602 of the handle 600 can provide an offset lacrosse stick.

Although FIG. 6 illustrates a handle 600 in which a first portion departs linearly from the axis of a second portion (e.g., dowel portion axis 608 departs linearly from main portion axis 610), in other embodiments, the first portion can depart from the second portion along a long and gradual curve. For example, instead of having linear portions 602 and 604 abutted to each other as is shown in FIG. 6, handle 600 could have an extended curved transition in between the linear portions 602 and 604 that transitions main portion axis 606 into dowel portion axis 608.

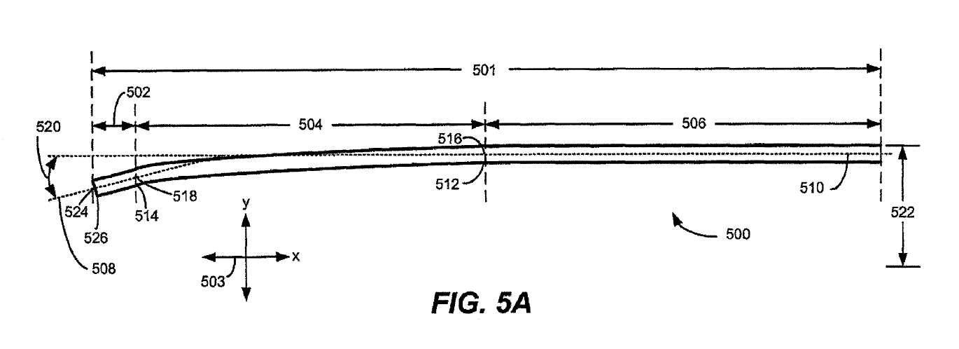

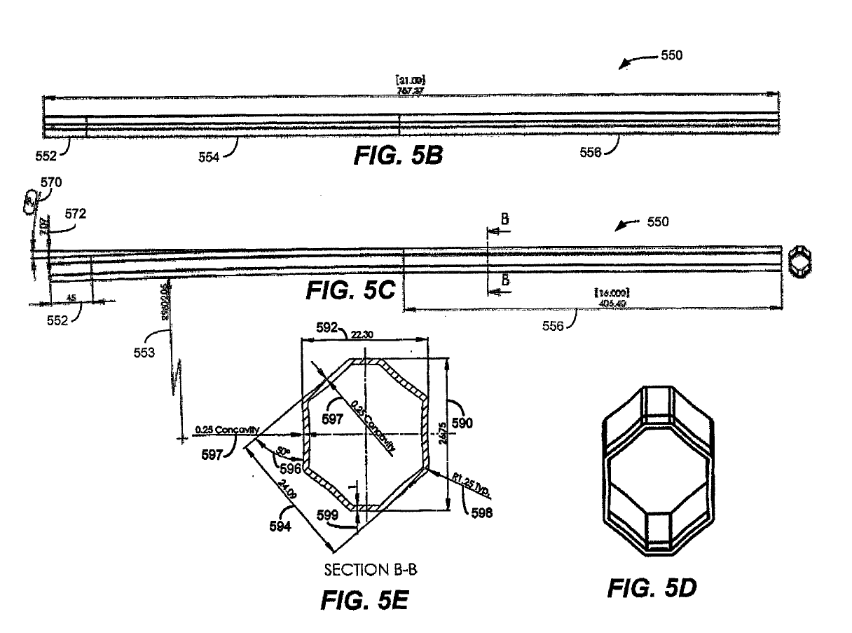

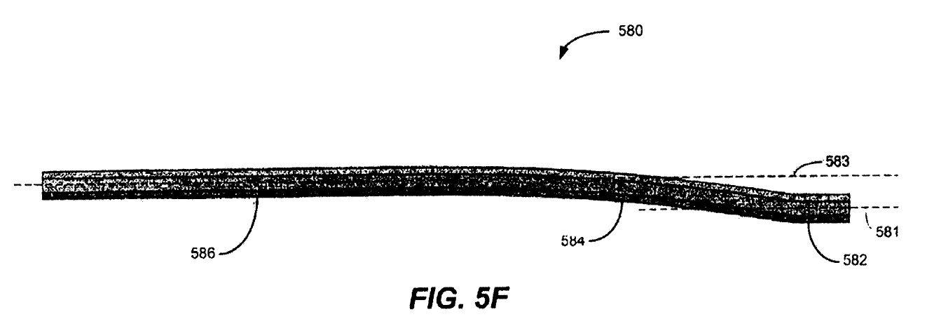

Thus, in addition to linear angular canting, other embodiments of the present invention can form curves or combinations of curves and linear angular cants. For example, according to one embodiment, as shown in FIG. 5A, a handle 500 has a linear main (or lower) portion 506, a curved intermediate portion 504, and a linear dowel portion 502. The curved intermediate portion 504, which is between the main portion 506 and the dowel portion 502, offsets the dowel portion 502 from the main portion 506 so that the longitudinal axis 508 of the dowel portion 502 is at an angle 520 to the longitudinal axis 510 of the main portion 506. Alternatively, the angle of offset can be measured based on the intersection of a first line drawn through the top linear surface of the main portion 506 in FIG. 5A and a second line drawn through the top linear surface of the dowel portion 502 in FIG. 5A.

In one embodiment, a lacrosse head having straight or offset sidewalls is attached to the straight dowel portion 502. As discussed in more detail below, due to the curved intermediate portion 504 and the linear dowel portion 502, it is not necessary to use a lacrosse head having an upward cant between its throat portion and its scoop, as disclosed, for example, in U.S. Pat. No. 7,488,266, which is assigned to the assignee of the present invention and which is herein incorporated by reference in its entirety. Instead, the lacrosse stick can have a lacrosse head having straight or offset sidewalls and still comply with commonly accepted rules of lacrosse that limit the distance below the top of main portion 506 that an attached lacrosse head can extend, as represented by arrow 522 in FIG. 5A. For example, the men's lacrosse rules promulgated by the National Collegiate Athletic Association (NCAA) currently set this distance 522 at about 2.75 inches. The test commonly used to evaluate lacrosse sticks against that NCAA rule is often referred to as the “tabletop test.”

Referring to FIG. 5A, an embodiment of the present invention provides an integrally formed monolithic lacrosse stick handle 500 having an overall length 501 in an x-direction of an x-y plane represented by arrows 503. As shown, the handle 500 comprises a linear main portion 506, an intermediate curved portion 504, and a linear dowel portion 502. The linear main portion 506 defines a first longitudinal axis 510 extending parallel to the x-direction within the x-y plane 503, wherein the length of the linear main portion 506 is approximately one half of the overall length 501. The linear dowel portion 502 defines a second longitudinal axis 508 within the x-y plane 503, and is configured to attach to a lacrosse head. The curved intermediate portion 504 is continuous with and disposed between the linear main portion 506 and the linear dowel portion 502. The curved intermediate portion 504 comprises a first end 512 adjacent to the linear main portion 506 and a second end 514 adjacent to the linear dowel portion 502. The curved intermediate portion 504 and the linear dowel portion 502 together extend in the x-direction for approximately one half of the overall length 501.

A first midpoint 516 of the first end 512 of the curved intermediate portion 504 is aligned with the first longitudinal axis 510 and a second midpoint 518 of the second end 514 of the curved intermediate portion 504 is aligned with the second longitudinal axis 508. The first midpoint 516 is above the second midpoint 518 with respect to the y-direction of the x-y plane 503. The curved intermediate portion 504 curves in a direction increasingly away from the first longitudinal axis 510 from the first midpoint 516 to the second midpoint 518 within the x-y plane 503. The first longitudinal axis 510 is at an angle 520 to the second longitudinal axis 508. The second longitudinal axis 508 of the linear dowel portion 502 extends from the second midpoint 518 increasingly away from the first longitudinal axis 510 from the second midpoint 518 to a midpoint 524 of a distal end 526 of the linear dowel portion 502.

FIGS. 5B-5E illustrates a particular implementation of a lacrosse handle 550 having a linear-curved-linear configuration when viewed from the side, according to an embodiment of the present invention. As shown in the bottom view of FIG. 5B, handle 550 has a linear configuration when viewed from the bottom (or top). Rotated ninety degrees, however, handle 550 has a nonlinear configuration as shown in FIG. 5C. With reference to FIGS. 5B and 5C, handle 550 comprises three contiguous portions: a linear main portion 556, a curved intermediate portion 554, and a linear dowel portion 552.

The overall length of handle 550 can be, for example, approximately 31 inches, with the main portion 556 being about 16 inches and the intermediate portion 554 and dowel portion 552 together being about 15 inches when measured from a top or bottom view (see FIG. 5B, for example). The length of dowel portion 552 measured parallel to its axis can be about 45 mm or about 1.77 inches, as shown in FIG. 5C. At that length, a majority of the length of the dowel portion can be substantially enclosed within a throat portion of a typical lacrosse head. The radius of curvature 553 of the intermediate portion 554 can be about 9,602 mm or 378 inches. These lengths and dimension provide an angular offset 570 between the dowel portion 552 and the main portion 556 of about two degrees as shown in FIG. 5C. In the schematic representation of FIG. 5C, that two degree offset is measured based on the top linear surface of the dowel portion 552 and the top linear surface of the main portion 556, as shown. As also shown, the offset lowers the top distal end of the dowel portion 552 a distance 572 of approximately 7 mm or 0.3 inches, below a line 574 drawn through the top linear surface of the main portion 556. FIG. 5D illustrates a left side view (end view) of the handle 550 in FIG. 5C showing the distal end of the dowel portion lowered below the main portion of the handle.

Alternatively, instead of providing an angular displacement between the dowel portion 552 and the linear main portion 556, another embodiment of the present invention positions the dowel portion 552 so that its longitudinal axis is parallel to the longitudinal axis of the linear main portion 556. FIG. 5F illustrates this alternative embodiment, in which a handle 580 has a linear dowel portion 582, a curved intermediate portion 584, and a linear main portion 586. As shown, the longitudinal axis 581 of the linear dowel portion 582 is parallel to the longitudinal axis 583 of the linear main portion 586.

FIG. 5E illustrates a cross-section of the lacrosse handle 550 of FIGS. 5B and 5C, taken at section B-B of FIG. 5C, according to an embodiment of the present invention. As shown, in this example, handle 550 has an octagonal cross-section with one pair of opposing short straight sides and three opposing pairs of longer concave sides. In this example, the height 590 is approximately 26.8 mm or 1 inch, the first width 592 is approximately 22.3 mm or 0.9 inches, and the second width 594 is approximately 24.1 mm or 0.95 inches. The angle 596 between the edges of the octagon can be approximately 50 degrees as shown. The concavity 597 of the three opposing pairs of longer concave sides can be about 0.3 mm, for example. The radius of curvature 598 of the corners between the edges of the octagon can be about 1.3 mm, for example. The wall thickness 599 can be about 1 mm, for example, as shown.

In a further aspect of the present invention, a lacrosse handle having a linear-curved-linear configuration can also have cross-sections of varying shapes over different portions of the handle, as described above in reference to FIGS. 1A-4E. For example, a lacrosse handle having a linear-curved-linear configuration could have differently shaped and sized cross-sections in each of a linear main portion, a curved intermediate portion, and a linear dowel portion.

The linear-curved-linear configurations shown in FIGS. 5A-E yield surprising benefits in comparison to handles that are curved their entire length and to canted handles having only linear sections (e.g., a handle having only a linear main portion and linear dowel portion, as in FIG. 6). Those benefits relate to, for example, hand placement as it affects shooting and passing accuracy and consistency, better positioning of the ball further underneath the hands (when a stick is viewed from the side, with the axis of the main portion of the handle horizontal), and due to the linear dowel portion and the degree of the curve in the curved portion, the ability to accommodate most existing lacrosse heads while complying with widely-accepted lacrosse stick construction rules limiting the total allowable offset of a lacrosse head.

The linear-curved-linear configurations allow a player to maintain conventional hand positioning on the bottom portion of the handle (linear main portion) since the bottom portion is straight. In a handle cambered its entire length, hand placement affects both the relative angle of the dowel to the hands and the distance of the ball to the effective centerline. Thus, unlike the present invention, small changes in hand positioning on a fully cambered handle greatly affect feel, accuracy, and consistency in both shooting and passing. In addition, in the present invention, placement of the ball is further below the top hand on the handle than would be the case with a fully cambered handle that meets the tabletop test. This configuration generates more power by creating a more defined slope of the top portion of the handle/head, forcing the ball to tuck under the shooting strings.

As an example of the benefits of the present invention, compared to a handle that is fully cambered or curved from one end to the other, small differences in the placement of a player's hand on the main portion 556 of the handle 550 of FIGS. 5B-E during shooting does not appreciably affect the location of the head or pocket because the main portion 556 is completely straight. In contrast, on a fully cambered shaft, variations in the placement of a player's bottom hand can affect the angle and location of the head and pocket for the shot or pass. Therefore, on fully cambered shafts, inconsistent hand placement between shots and passes can greatly affect accuracy and consistency. In the present invention, the straight main portion 556 extending from approximately the midpoint of the handle down allows hand placement to vary slightly between shots without affecting accuracy and consistency at all.

In comparison to handles having only linear sections at angles to each other (e.g., a handle having only a linear main portion and linear dowel portion, as in FIG. 6), the embodiments of FIGS. 5A-5E place more of the shaft and head further beneath the hands, therefore moving the center of gravity further below the hands, which improves the tendency of the ball to center in the pocket during shots and cradling maneuvers. This also improves the biomechanical advantage gained from the handle in the shot motion in a way that the linear angle alone does not. In addition, in the present invention, if a player's top hand is in a cradle position on the shaft just below the throat of the head, the head position is the same as on a completely straight handle. In contrast, on a completely linear canted handle, because the throat of the lacrosse head often covers the entire length of the dowel portion, when a player's top hand is in a cradle position, the angle of the throat of the head encompassing the dowel portion of the handle to the long linear section of the handle can interfere with a player's natural grip and contribute to difficulty in ball retention.

The linear-curved-linear configuration also enables conformance with the commonly accepted tabletop rule. Completely linear canted handles that have larger angles of displacement (e.g., ten degrees) may require unique upwardly canted heads designed only for use with the handles as a system, in order to comply with the tabletop test. In contrast, the linear-curved-linear configuration of FIGS. 5A-E can accommodate traditional straight and offset lacrosse heads while still complying with the tabletop test.

The handle configuration of FIGS. 5A-E also provides benefits related to the location of curved intermediate portion, to the specific angle chosen (e.g., a preferred angle being two degrees), and to the tangency of the curve to both straight portions (the insertion into the head is straight for compatibility with existing heads). The location and severity of the curved portion helps determine the displacement of the center of gravity (as noted above) as well as the interaction with the player's grip placement during maneuvering, passing, shooting, and other actions. The specific angle of the linear dowel portion can be a factor in the release point during a shot, which can provide for improved biomechanical advantage. Conversely, extreme angles are less preferable because they can reduce performance and cause a lack of playability due to non-ideal biomechanical positioning. The tangency of the portions provides for a smooth transition between linear and curved segments. This allows the player to smoothly slide his hands along the shaft as needed for better playability.

In the embodiments shown in FIGS. 5A-5E, the linear main portion of the handle is approximately one half the overall length of the handle and the curved intermediate portion and linear dowel portion together are approximately one half the overall length. Typical hand positions for shooting, passing, etc. are generally at or below the centerpoint of the handle; therefore by maintaining this approximate half portion (linear main portion) as linear, there is no adjustment needed by the player to accommodate any curvature of the shaft. This allows a player who is used to a standard straight shaft, to quickly adapt to playing with the handle of the present invention. In addition, slight adjustments in hand position on the linear main portion will not cause relative displacement or orientation changes in the head, leading to more consistent performance. However, as one of ordinary skill in the art would appreciate, the lengths of the different portions, and their lengths relative to each other, can vary to provide different play characteristics. For example, the linear main portion could comprise two-thirds of the overall length of a handle.

As another example, in the case of a longer handle (e.g., greater than 31 inches, such as with typical defensive length handles), the linear main portion could comprise less than half of the overall length of a handle, for example, one-quarter the length or even shorter. Or, alternatively, in the case of a longer handle the linear main portion could comprise more than half the overall length of a handle, for example, three-quarters of the length or longer. Because of the added length of the defensive handles, the linear main portion can be over half the overall length of the handle while still providing a considerably long curved intermediate portion to provide the benefits described above. Defensive length handles of approximately 60 inches in length are typically held with the bottom hand offset from the end of the shaft, in contrast to shorter handles (e.g., 31 inches). In order to give the same advantages as on a shorter handle, a longer linear portion that encompasses typical hand positioning offset from the bottom end of the shaft may be advantageous.

Therefore, notwithstanding the particular benefits associated with the proportions shown in FIGS. 5A-5E, the present invention should be considered broadly applicable to linear-curved-linear configurations having lower, intermediate, and dowel portions of lengths different from those shown in FIGS. 5A-5E.

With reference to the embodiment shown in FIG. 5F, the linear-curved-linear lacrosse handle 580, with its linear dowel portion 582 not tangent to the curved intermediate portion 584, and its longitudinal axis 581 of the linear dowel portion 582 parallel to the longitudinal axis 583 of the linear main portion 586, provides many of the benefits of the linear-curved-linear configuration of, for example, FIGS. 5A and 5C, while providing a user experience closer to that of a standard straight shaft with some unique benefits. For example, while retrieving lacrosse balls on the ground, the head angle is the same as for a standard straight handle, while being further below the hands, leading to easier ground ball pickup with less bending over by the player as compared to a linear handle and less angle to vertical as compared to a tangent linear-curved-linear configuration as shown in FIGS. 5B-5D. The benefits of a lower center of gravity and increased polar moment of inertia while cradling, namely the improved tendency of the ball to center in the pocket, are still evident in this embodiment. The embodiment shown in FIG. 5F also provides for compliance with the tabletop test for many head designs.

In order to precisely and conveniently form the varying cross-sections of FIGS. 1A-4D, or the combination of linear and curved portions of the lacrosse handles of FIGS. 5A-F, embodiments of the present invention provide methods for hydroforming or high pressure bladder molding handles within an appropriately shaped mold. The hydroforming or high pressure bladder molding methods described above in the context of varying cross-sections also apply to the formation of handles that change in direction, for example, to create curved and linear configurations. In comparison to conventional metal-forming and bending techniques, hydroforming metal handles integrally forms more precise changes in direction, curves, and straight portions, all within tight tolerances. In comparison to conventional composite extrusion techniques, high pressure bladder molding can accomplish the same for composite handles. In addition, hydroforming or high pressure bladder molding integrally forms multiple complex shapes and changes in direction in one step, whereas conventional bending techniques may require many different steps to set up tools and curve and bend a work piece. As a further benefit, hydroforming and high pressure bladder molding causes the polymer-based composite or metal material to flow evenly into a dye rather than stretch or bend, which produces less material thinning, and also reduces mechanical weakening of the walls.

In an embodiment of the present invention, metal lacrosse handles having variable cross-sectional shapes, sizes, and/or areas are formed by hydroforming, which is a specialized type of dye forming that uses a high pressure hydraulic fluid to press room temperature working metal material into a dye. A preformed hollow tube is placed inside a negative mold that has the shape of the desired lacrosse handle. The tube can be made of a malleable metal, such as a metal alloy (e.g., a zirconium-aluminum alloy, a vanadium-steel alloy, a vanadium-aluminum alloy, a titanium-aluminum alloy, or a scandium-aluminum alloy). The tube can be open ended or closed at one end (e.g., if a butt cap is being integrally formed). A fluid is injected inside the tube under high pressure, which causes the tube to expand against the mold until it matches the shape of the mold. The hydroformed part is then removed from the mold.

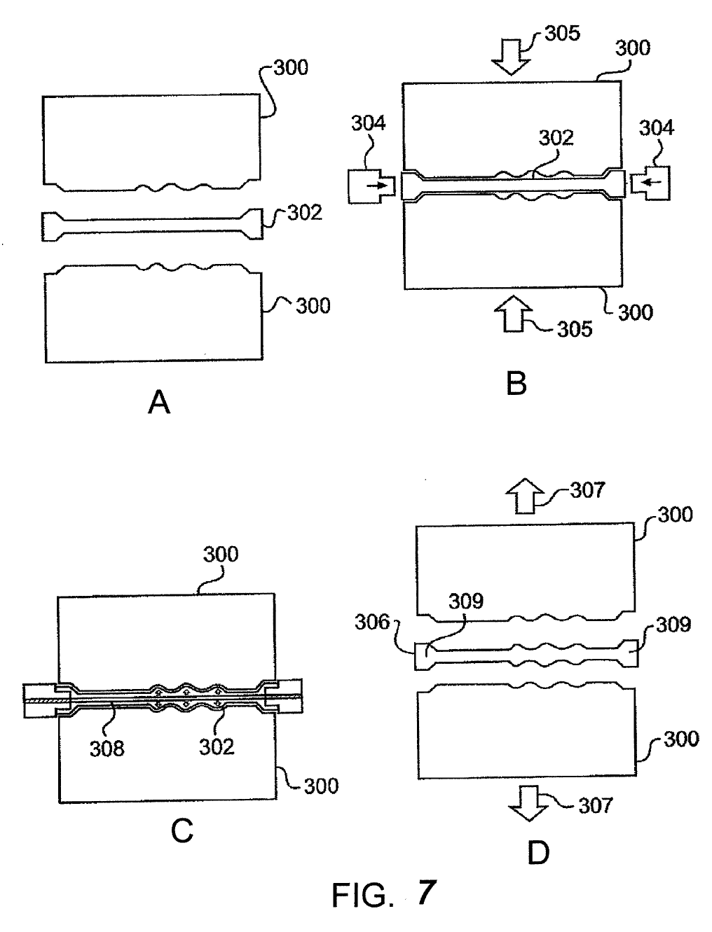

FIG. 7(A-D) illustrates a hydroforming process according to an embodiment of the present invention. As shown in FIG. 7A, a metal tube 302, in this case having two open ends, is placed into an open mold 300 having a top and bottom tool. As shown in FIG. 7B, the top and bottom tool then close onto the metal tube 302 as represented by the arrows 305, with the two open ends of the metal tube 302 exposed at the sides of top and bottom tool. Two side high pressure water jets 304 are then inserted into the two open ends of the metal tube 302 until they completely seal the open ends. As shown in FIG. 7C, at room temperature, high pressure water 308 is pushed into the metal tube 302 through the open ends, which pushes the walls of the tube 302 outward and against the inside walls of the top and bottom tool. Then, as shown in FIG. 7D, the top and bottom tool open (as represented by the arrows 307) to expose the hydroformed metal tube 306. The ends of hydroformed metal tube 306 can be cut square, ground, or otherwise finished to provide a final handle suitable for play. In one embodiment, in which the ends of tube 302 are expanded in diameter to accommodate the connections to the high pressure water jets 304, the expanded portions 309 of the hydroformed metal tube 306 are cut off.

In an embodiment of the invention, the cycle time for the hydrodynamic manufacturing process shown in FIGS. 7A-7D is one to five minutes per part, depending on manufacturing parameters such as shape and wall thickness.

According to another embodiment of the present invention, the above-described lacrosse handles are formed by high pressure bladder molding of composite material, a different type of dye forming that relies on a pneumatically-inflated bladder topress composite working material into a dye. The basic steps of high-pressure bladder molding comprise: 1) taking a composite preform of the handle; 2) place composite preform into a preset mold (mold usually aluminum or steel); 3) insert an inflatable bladder; 4) pre-heat mold; 5) pneumatically inflate the bladder to exert high pressure from the inside; and 6) curing. During curing, the composite hardens and holds the shape of the mold.

In step 1, any polymer-based composite material may be used, including fiberglass, carbon fiber, or Kevlar™, for example. The composite material is formed in a preform structure approximating the negative mold cavity, e.g., a hollow composite tube shaped lengthwise to fit the negative mold that has the shape of the desired lacrosse handle.

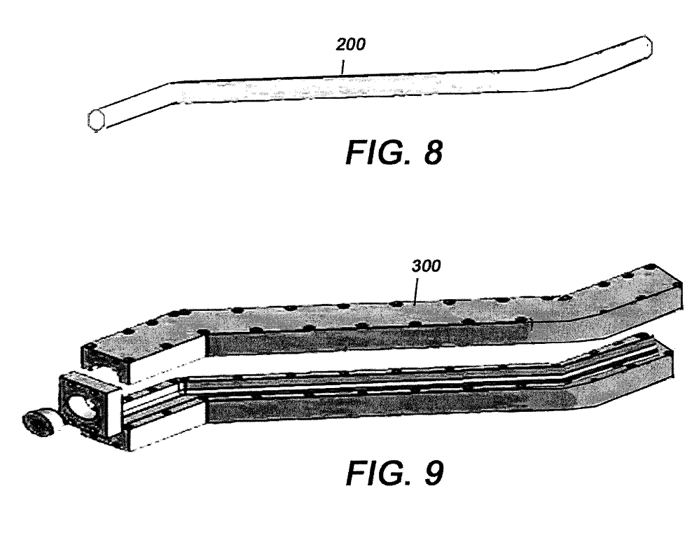

FIG. 8 is an example of a suitable composite preform 200 approximating the shape of a handle having a linear-curved-linear configuration according to the embodiment of FIG. 5A.

Step 2 comprises obtaining a mold having a mold cavity configured to facilitate formation of the desired composite article, e.g., the interior walls of the mold define the varying cross-sections of FIGS. 1A-4D, or the combination of linear and curved portions of the lacrosse handles of FIGS. 5A-F.

FIG. 9 is an example of a suitable clamshell mold 300 for forming the above-described lacrosse handles having variable cross-sectional shapes, sizes, and/or areas from composite preform 200. The mold 300 may be constructed of opposing aluminum sections having an internal cavity defining the desired outer shape of the lacrosse handle.

Step 3 comprises placement of a flexible bladder inside the preform 200, and coupling the bladder to a nozzle external to the mold 300. The bladder may be a conventional latex bladder. Once the preform 200 and bladder are properly positioned within the mold 300 cavity, the mold cavity is closed to provide a suitable enclosure for forming the composite handle.

Step 4 comprises heating the mold 300 and preform 200 to a pre-determined temperature in cooperation with a pre-determined molding temperature, preferably 175 degrees F. Once heating of the preform 200 has begun, the temperature may be monitored to determine whether a proper molding temperature has been achieved. Once the preform 200 has reached the proper desired molding temperature, at step 5 the bladder is inflated pneumatically to within a range of from 200-300 psi. The bladder causes the preform 200 to conform to the interior walls of the mold 300. The bladder is removed, the preform 200 checked to ensure that it is properly formed, and the process repeated until the preform 200 retains the desired shape. At step 6, once properly formed, the preform 200 may be cooled to produce the final handle. The present invention bladder molding process, permits polymer composite preforms with or without reinforcing fibers to be used to form any of the varying cross-sections of FIGS. 1A-4D, or the combination of linear and curved portions of the lacrosse handles of FIGS. 5A-F.

FIGS. 4A-4D illustrates the high pressure bladder molding process according to an embodiment of the present invention. As shown in FIG. 4A, a composite preform 200, in this case a tube having two open ends, is placed into an open mold 300 having a top and bottom section. As shown in FIG. 4B, the top and bottom sections of mold 300 are closed onto the composite preform 200 as represented by the arrows 305, with the two open ends of the preform tube 200 exposed at the sides of top and bottom of mold 300. A flexible bladder is inserted inside the preform 200, and the bladder is coupled to a high pressure air supply 304 that completely seals the bladder. As shown in FIG. 4C, at room temperature, high pressure air 308 inflates the bladder through the open end, which pushes the walls of the preform tube 200 outward and against the inside walls of the top and bottom mold 300 sections. Then, as shown in FIG. 4D, the top and bottom of mold 300 is opened (as represented by the arrows 307) to expose the bladder molded handle. The ends of the bladder molded handle can be cut square, ground, or otherwise finished to provide a final handle suitable for play.

In an embodiment of the invention, the cycle time for the bladder molding manufacturing process shown in FIGS. 4A-4D is one to five minutes per part, depending on manufacturing parameters such as shape and wall thickness.

A further aspect of the present invention enhances grip on a transitioning lacrosse head as described above, by applying a coating having a coefficient of friction higher than the material from which the handle is formed. For example, a rubberized grip coating can be provided on a metal handle. The rubberized grip coating can be applied in a secondary manufacturing process in which, for example, the coating is sprayed onto the handle and heated.

The embodiments of the present invention described above apply equally well to men's lacrosse sticks, to women's lacrosse sticks, to sticks for players of all sizes and ages, to sticks used in competition lacrosse (e.g., professional, club, and box lacrosse, and lacrosse governed in whole or in part by NCAA or U.S. Women's Lacrosse Association rules), and to sticks used in non-competition lacrosse (e.g., recreational and instructional lacrosse sticks used in physical education classes). In each application, the present invention is adaptable to provide unique advantages for different types of players. For example, for men's lacrosse sticks, the present invention can provide undulating octagonal portions of a larger width to accommodate larger hands and provide improved grip and feel.

Other embodiments of the invention will be apparent to those skilled in the art from consideration of the specification and practice of the invention disclosed herein. It is intended that the specification and examples be considered as exemplary only, with a true scope and spirit of the invention being indicated by the claims. In addition, as one of ordinary skill in the art would appreciate, any dimensions shown in the drawings or described in the specification are merely exemplary, and can vary depending on the desired application of the invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A lacrosse stick handle having an overall length in an x-direction of an x-y plane, the handle having a finished shape comprising a linear main portion defining a first longitudinal axis extending parallel to the x-direction within the x-y plane, wherein the length of the linear main portion is approximately one half of the overall length, a linear dowel portion defining a second longitudinal axis within the x-y plane, wherein the linear dowel portion is configured to attach to a lacrosse head, and an intermediate portion contiguous with and disposed between the linear main portion and the linear dowel portion, the intermediate portion comprising a first end adjacent to the linear main portion and a second end adjacent to the linear dowel portion, said intermediate portion being non-parallel to both said first longitudinal axis and said second longitudinal axis, said lacrosse stick handle being constructed by dye forming a preform in accordance with the following steps:
taking a composite preform comprising a handle material preformed in a tubular configuration;
placing said tubular preform in a mold having a negative mold cavity conforming to said finished shape including said non-parallel intermediate portion contiguous with and disposed between the linear main portion and the linear dowel portion;
pumping fluid into the mold under pressure said preform conforms to said finished shape established by said mold cavity.

2. The lacrosse stick handle according to claim 1, wherein said dye forming further comprises high pressure bladder molding a composite preform, said step of taking a composite preform comprises taking a polymer composite material preformed in a tubular configuration, and said construction process further includes the steps of inserting an inflatable bladder into said tubular preform, heating said mold, pumping fluid into the bladder under pressure for inflation thereof until said lacrosse stick handle conforms to said finished shape established by said mold cavity, and curing said lacrosse stick handle to maintain said finished shape.

3. The lacrosse stick handle according to claim 1, constructed by hydroforming a metal preform in accordance with the following steps:
taking a preform comprising a metal handle material preformed in a tubular configuration;
placing said tubular preform in a mold having a negative cavity conforming to said finished shape;
pumping fluid into the mold under pressure said preform conforms to said finished shape established by said mold cavity.

4. The lacrosse stick handle of claim 1, wherein the linear dowel portion has a length so dimensioned that a majority of the length of the linear dowel portion is enclosed within a throat portion of the lacrosse head.

5. The lacrosse stick of claim 1, wherein the overall length is approximately 31 inches and the length of the linear dowel portion is approximately 1.8 inches.

6. The lacrosse stick handle of claim 1, wherein the angle is approximately two degrees.

7. The lacrosse stick handle of claim 6, wherein the linear main portion defines an uppermost surface with respect to the y-direction, the distal end of the linear dowel portion defines an uppermost edge with respect to the y-direction, and the uppermost edge of the distal end is approximately 7.1 mm below a line drawn through the uppermost surface.

8. The lacrosse stick handle of claim 1, wherein the intermediate portion is curved along its length.

9. The lacrosse stick handle of claim 8, wherein the curved intermediate portion has a radius of curvature of approximately 9,602 mm between the first midpoint and the second midpoint.

10. The lacrosse stick handle of claim 1, wherein the handle is integrally formed from a thermoplastic polymer material.

11. A method for forming a lacrosse stick handle having an overall length in an x-direction of an x-y plane, the method comprising:
inserting a hollow tube made of polymer material into a cavity of a negative mold, the negative mold defining a shape along the length of the cavity that defines at least one nonlinear portion;
placing an inflatable bladder into said hollow tube;
heating said negative mold and hollow tube;
injecting a fluid into the bladder under pressure such that the hollow tube expands and is pressed against the negative mold until said hollow tube matches the shape of the cavity;
releasing the pressurized fluid;
cooling said negative mold and hollow tube such that the hollow tube maintains the shape of the cavity, thereby forming the hollow tube into a lacrosse stick handle having a linear main portion defining a first longitudinal axis extending parallel to the x-direction within the x-y plane, wherein the length of the linear main portion is approximately one half of the overall length, a linear dowel portion defining a second longitudinal axis within the x-y plane, wherein the linear dowel portion is configured to attach to a lacrosse head, and a curved intermediate portion continuous with and disposed between the linear main portion and the linear dowel portion, wherein the curved intermediate portion comprises a first end adjacent to the linear main portion and a second end adjacent to the linear dowel portion, wherein the curved intermediate portion and the linear dowel portion together extend in the x-direction for approximately one half of the overall length, wherein a first midpoint of the first end of the curved intermediate portion is aligned with the first longitudinal axis and a second midpoint of the second end of the curved intermediate portion is aligned with the second longitudinal axis, wherein the first midpoint is above the second midpoint with respect to the y-direction, and wherein the curved intermediate portion curves increasingly away from the first longitudinal axis from the first midpoint to the second midpoint within the x-y plane, wherein the first longitudinal axis is at an angle to the second longitudinal axis, and wherein the second longitudinal axis of the linear dowel portion extends from the second midpoint increasingly away from the first longitudinal axis from the second midpoint to a midpoint of a distal end of the linear dowel portion; and removing the lacrosse stick handle from the negative mold.

12. The method of claim 11, further comprising connecting a lacrosse head to the linear dowel portion.

13. The method of claim 11, further comprising inserting the linear dowel portion of the lacrosse stick handle into a socket of a lacrosse head that encloses a majority of the length of the linear dowel portion.

14. The method of claim 11, further comprising integrally forming a closed end on the linear main portion.

15. The method of claim 14, wherein the closed end comprises a butt cap.

16. A lacrosse stick handle having an overall length in an x-direction of an x-y plane, the handle comprising a portion along at least one-third of said handle in said x-direction having an oscillatory surface texture to provide a grip.

17. The lacrosse stick handle according to claim 16, wherein said oscillatory surface texture is undulating in said x-direction.

18. The lacrosse stick handle according to claim 17, wherein said oscillatory surface texture is sinusoidal in said x-direction.

19. The lacrosse stick handle according to claim 17, wherein said oscillatory surface texture comprises a stepped ramp in said x-direction.

20. The lacrosse stick handle according to claim 19, wherein said surface texture replicates tape wound about said handle.

21. The lacrosse stick handle according to claim 17, wherein said oscillatory surface texture is a step wave in said x-direction.

22. The lacrosse stick handle according to claim 21, wherein said surface texture replicates tape wound about said handle.

23. The lacrosse stick handle according to claim 17, made by hydroforming a preformed tubular blank.

24. The lacrosse stick handle according to claim 23, wherein said preformed tubular blank is metal.

25. The lacrosse stick handle according to claim 17, made by bladder molding a preformed tubular blank.

26. The lacrosse stick handle according to claim 25, wherein said preformed tubular blank is composite material.
